(19) United States
(12) Patent Application Publication
(10) Pub. No.: US 2025/0364741 A1
(43) Pub. Date: Nov. 27, 2025

(54) DAUGHTER CARD LOCKING MODULE FOR AUTOMOTIVE APPLICATIONS

(71) Applicant: FCI USA LLC, Etters, PA (US)

(72) Inventors: Steven E. Minich, York, PA (US); Mark R. Gray, York, PA (US); Scott Carbaugh, Orbisonia, PA (US)

(73) Assignee: FCI USA LLC, Etters, PA (US)

(21) Appl. No.: 18/873,708

(22) PCT Filed: Jun. 13, 2023
(86) PCT No.: PCT/US2023/025228

§ 371 Date: Dec. 10, 2024

Related U.S. Application Data
(60) Provisional application No. 63/351,795, filed on Jun. 13, 2022.

(51) Int. Cl. H01R 12/73; H01R 12/70

(52) U.S. Cl. CPC H01R 12/737; H01R 12/7029; H01R 12/7052; H01R 12/7088; H01R 2201/26

(57) ABSTRACT

A high-speed, high-density, vibration resistant interconnection system. The connector may be assembled from connector modules designed for a high-speed, high-density interconnection system operated in a controlled environment. These modules may be designed for mounting to PCBs in linear arrays that define connectors. The connectors may be adapted for use in a high-vibration environment through locking features integrated into the linear arrays. In a first connector, the locking features may be part of a locking module, integrated with other connector modules, such as signal modules, power modules and guidance modules. In a second, complementary connector, the locking features may be features in the PCB, such as holes, that engage the locking module of the first connector.

### FIELD

This application relates generally to electrical interconnection systems used to interconnect electronic components and more specifically to those providing high density and high speed interconnects.

### BACKGROUND OF INVENTION

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components. These interconnection systems are achieved through board-to-board connectors in which each of two mating connectors is mounted to a PCB and mating the connectors establishes multiple connections between those PCBs.

High speed and high density board to board connectors have been used to route signals to or from processors and other electrical components that process a large number of high speed signals. These connectors are designed so as not to degrade those signals to a significant degree. Connectors designed to interconnect printed circuit boards, for example, provide low attenuation of the signals passing to or from these components. Additionally, the connectors are designed not to introduce crosstalk into the signal, cause signal reflections or other signal distortions. Such connectors are also typically designed to be used in a relatively controlled environment, such as in a server room.

Connectors designed for use in automobiles or other vehicles conventionally are not designed for a large number of high-speed signals. Rather, automotive connectors are often designed with features to enable the connectors to operate in the more demanding environment in an automobile. For example, connectors in automobiles are often subject to vibration, which may degrade the performance of the connector. Resistance to vibration may be provided if one or both of a pair of mating connectors is a cable connector.

A cable connector terminating a cable, which is flexible, is free to move with a mating connector, even if the mating connector is mounted to a PCB. As a result, when the mated connectors are subjected to vibration, the mated connectors do not move relative to each other such that there is little sliding of the mating contact surfaces of one connector on the mating contact surfaces of the other connector. This sliding causes fretting on the contact surfaces, which can ultimately lead to connector failure. Using a cabled connection avoids or greatly delays these vibration-induced failures in automotive connectors.

For high-speed signals, each signal may pass through a twisted pair of wires. Where multiple signals are to pass between subassemblies in an automobile, multiple twisted pairs may be bundled into a cable. Each end of that cable may be connected to a subassembly, such that multiple subassemblies may be joined through the cable. At least one end of the cable may terminate in a cable connector, which may mate with a board connector on one of the subassemblies.

### SUMMARY OF INVENTION

Aspects of the present disclosure relate to high speed, high density connectors.

Some embodiments relate to a locking module configured for use with board-mounted connector modules, the locking module comprising a first surface and a second surface, a plurality attachment posts extending from the first surface, a threaded hole in the first surface, and a plurality of pegs extending from the second surface, wherein the plurality of pegs are threaded.

Optionally, the locking module comprises an integral body comprising the first surface, the second surface, the plurality of attachment posts, the threshed hole and the plurality of pegs.

Optionally, the second surface is perpendicular to the first surface.

Optionally, the locking module is metal.

Optionally, the plurality of attachment posts comprise projections.

Optionally, the plurality of attachment posts are configured to making an interference-fit attachment when pressed into holes of a PCB.

One or more of the concepts described herein may be embodied as an electrical connector, for example, comprising any of the locking modules described herein in combination with a plurality of signal modules, wherein the plurality of signal modules and the locking module arc disposed in a linear array.

Optionally, the electrical connector further comprises a support member, wherein the locking module and the plurality of signal modules are attached to the support member.

Optionally, the locking module is a first locking module, and the electrical connector comprises a second like locking module.

One or more of the concepts described herein may be embodied as an automotive electronic system comprising the electrical connector described herein, in combination with a first printed circuit board and a second printed circuit board, wherein the second printed circuit board has holes therethrough, the electrical connector is mounted to the first printed with the first surface of the locking module mounted against a surface of the first printed circuit board, the first connector is mated to a second connector mounted to the second printed circuit board and the plurality of pegs extend through the holes of the second printed circuit board.

Optionally, the automotive electronic system further comprises a screw passing through the first printed circuit board and engaging the threaded hole in the locking module and a plurality of nuts threaded on the plurality of pegs holding the second surface of the locking module against a surface of the second printed circuit board.

One or more of the concepts described herein may be embodied as an electrical connector configured to mate with a complementary connector and configured for mounting to a first surface of a printed circuit board (PCB), the electrical connector comprising a plurality of modules configured for mounting to the first surface of the PCB of components configured, wherein the plurality of modules comprise one or more locking modules configured to secure the complementary connector to the electrical connector, a power module comprising a plurality of power contacts disposed in a cavity of a first housing, a signal module comprising a plurality of signal contacts, and one or more guiding modules, each of the guiding modules comprising a shell with a first opening in the first direction.

Optionally, each of the one or more locking modules comprises one or more pegs, and the one or more pegs are configured to pass through one or more corresponding holes through the PCB.

Optionally, each of the one or more locking modules comprises a first surface configured for mounting against the first surface of the PCB, a threaded hole in the first surface of the locking module, and the connector further comprises a screw configured to pass through a hole in the PCB and engage the threaded hole so as to secure the locking component to the PCB.

Optionally, each of the plurality of power contacts is bifurcated.

Optionally, each of the plurality of bifurcated power contacts comprise a first and second prong having a rest state, and wherein the prongs are offset towards each other when the electrical connector is mated with the complementary connector.

Optionally, each of the one or more locking components comprise a threaded peg configured to be inserted through a hole of a board to which the complementary connector is mounted.

Optionally, the signal module comprises a plurality of recesses, each of the plurality of recesses comprising two opposing sides, signal terminals of the plurality of signal contacts are disposed along the two sides of each recess of the plurality of recesses so as to provide a mating interface configured to mate with signal contacts on two sides of a corresponding protrusion of the complementary connector when the complementary connector is mated to the connector.

One or more of the concepts described herein may be embodied as a subassembly of an automotive electronic system. The subassembly may include a printed circuit board (PCB) comprising a surface and a plurality of holes therethrough and an electrical connector comprising a plurality of modules disposed in a linear array on a first surface of the PCB, wherein the plurality of modules comprise one or more of a power module, a signal module or a guiding module, the plurality of holes through the printed circuit board are configured to receive a threaded peg, and the plurality of holes through the printed circuit board are disposed in the linear array between adjacent ones of the plurality of modules.

Optionally, the connector comprises the signal module and the signal module comprises one or more recesses, signal contacts disposed within the recesses and configured to mate with signal contacts of a complementary connector when the complementary connector is mated to the electrical connector.

Optionally, the connector comprises the power module and the power module includes a receptacle, the receptacle including one or more recesses configured to receive power contacts of a complementary connector.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an illustrative interconnection system within an electronic device, in accordance with some embodiments.

FIG. 2 is a perspective view of a first exemplary board connector of the interconnection system of FIG. 1, in accordance with some embodiments.

FIG. 3A is a front, top perspective view of a second exemplary board connector of the interconnection system of FIG. 1, in accordance with some embodiments.

FIG. 3B is a front, bottom perspective view of the second exemplary board connector of FIG. 3A.

FIG. 4 is a perspective view of a locking module of the board connector of FIG. 3A-B, in accordance with some embodiments.

FIG. 5A is an alternative perspective view of the interconnection system of FIG. 1.

FIG. 5B is a side view of the interconnection system of FIG. 1.

FIG. 5C is a top plan view of the interconnection system of FIG. 1.

FIG. 6A is a side view of an alternative configuration of an illustrative interconnection system in an electronic device in which multiple daughter boards are connected to a motherboard.

FIG. 6B is a plan view of an exemplary motherboard of the interconnection system of FIG. 6A.

### DETAILED DESCRIPTION

The inventors have recognized and appreciated designs for economically enabling high speed and high-density interconnects systems in an automobile or other high-vibration environments. These interconnect systems may provide lower cost and/or occupy a smaller volume than conventional automotive interconnection systems for high-speed signals. As a result, they may enable automobile designers to readily incorporate multimedia and other high-bandwidth functionality into automobiles.

Connectors for such an interconnect system may be based on components for board-to-board interconnects, leveraging designs for high-speed and high-density interconnects, such as are used within switches, servers and other high-bandwidth electronic devices that conventionally operate in controlled environments. An example of such connectors are referred to as backplane connectors. These board-to-board connector components may be integrated with additional components that make the interconnections resistant to vibration.

In one aspect, an interconnection system for an automobile may be assembled from board-to-board connector modules in combination with a locking module designed to prevent relative movement between the board-to-board connector modules that couple data signals and/or power between two PCBs. The locking module may be configured for attachment to each of two PCBs or other substrates that are to be interconnected through the board-to-board connector modules.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

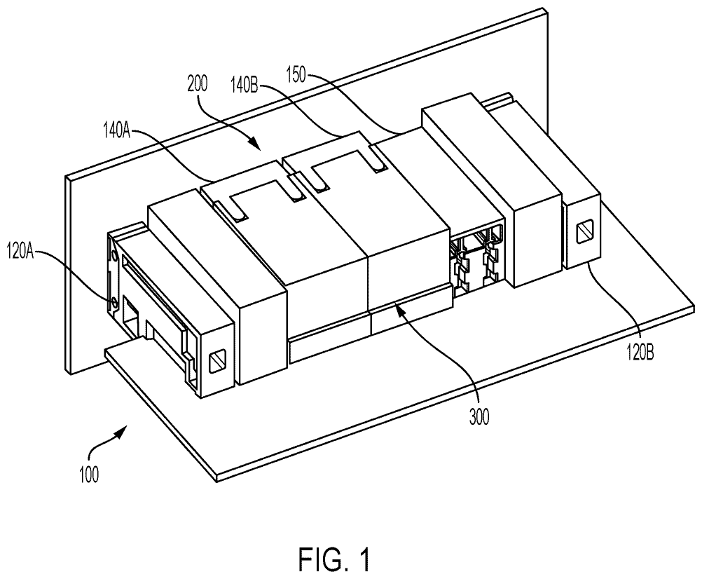

FIG. 1 is a perspective view of an illustrative interconnection system 100, in accordance with some embodiments. In some embodiments, the interconnection system may be used to connect two subassemblies to one another. Each subassembly may be implemented with a PCB such that the interconnection system provides a board-to-board connection. Semiconductors and other electronic components may be attached to the PCB to implement the functions of the subassembly and the connectors, also mounted to the PCBs, may make connections for signal and power passing between the components of the subassemblies.

The connectors may be based on designs for high density board-to-board connectors such as are used in network switches or other electronic devices with a high density of signals. The connectors, for example, may provide a density of more than 20 differential signals per inch (measured along the edge of the PCB to which the connector is mounted), such as at least 25, 30, or 40 differential signals per inch, in some examples. These connectors may occupy a volume that extends less than 2 inches from the surface of the PCB to which they are mounted.

These connectors may be based on designs for high-speed board-to-board connectors such as are used in servers or other electronic devices that operate on high-speed signals. The connectors, for example, may be designed to carry 25 Gb/s or 56 Gb/s. These connectors may have signal paths with impedance variations of less than 5% on signal paths through the mated connectors, or less than 3% or less than 2%, in some examples. These connectors may introduce less than 3 dB of insertion loss at 15 GHZ, in some examples. These connectors may introduce less than −40 dB of crosstalk at frequencies up to 15 GHz, in some examples.

The interconnection system 100 may be used in high data rate applications. For example, interconnection system 100 may connect a PCB with electronic components implementing a display driver to a PCB with nonvolatile memory that may store video content for display on a vehicle's on-board video system.

In the example of FIG. 1, the interconnection system 100 comprises a first connector 200 mated to a second connector 300. Each of the first and second connectors 200 and 300 may be made up of modules configured for mounting on a printed circuit board (PCB). The modules may be attached to a support member, such as a metal stiffener or plastic housing, before being mounted to a PCB. Alternatively or additionally, some or all of the modules forming a connector may be mounted individually to a PCB without first being connected to other modules of the connector. In such a scenario, the PCB itself may serve as a support member. The modules may be mounted to the PCB in an array to mate with modules in a similar array attached to another PCB. In the example of FIG. 1, each of the connectors 200 and 300 is shown mounted to a respective PCB. For simplicity of illustration, a support member and electronic components mounted to the PCBs and other connections to the PCBs are not expressly shown. In this example, the modules are mounted to PCBs in linear arrays.

Each of the modules of each of the connectors 200 and 300 mates to one or more modules of the other connector. Each of the connectors 200 and 300 may contain modules of different configurations, which may serve different functions, such as conveying power, signals or providing guidance for aligning the two connectors for mating. In the example of FIG. 1, there is a one-to-one correspondence between modules such that each module mates to a complementary module. For example, there may be one or more mated power modules 150, one or more mated guiding modules 120A and 120B, and one or more signal modules 140A and 140B.

In this example, the power modules, signal modules and guidance modules may be commercially available modules, such as backplane connector modules. An example of suitable commercially available modules is EXAMAX® connector modules sold by Amphenol Corporation. Locking modules 330A and 330B may be sized to fit into the same connector as these commercially available modules.

One or both of the connectors may include locking modules. In this example, connector 300 includes locking modules 330A and 330B for restraining relative movement of connectors 200 and 300 when the connectors are mated. In this example, locking modules 330A and 330B secure connectors 200 and 300 because they are rigidly attached to the PCBs to which those connectors are mounted. As a result of the rigid attachment to the PCBs, relative motion of the PCBs, and therefore relative motion of the connectors mounted to those PCBs, is restrained.

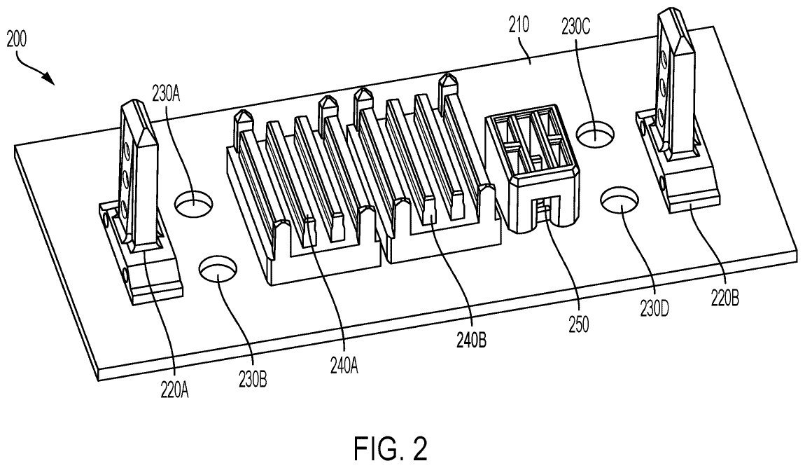

FIG. 2 is a perspective view of a first exemplary board connector 200 of the interconnection system of FIG. 1 mounted to a PCB 210. As described herein, the board connector 200 may include several modules mounted on printed circuit board (PCB) 210. Each of the modules may be configured to mate with a corresponding module of connector 300. Exemplary connector 200 includes modules such as power module 250, one or more guidance modules 220A and 220B, and one or more signal modules 240A and 240B. In this example, the modules are integrated into a connector 200 when they are attached to PCB 210 in a linear array in which they may mate to a mating connector.

### Power Modules of a First Connector

According to some embodiments, a first power module 250 is configured to mate with a second power module 350, forming mated power modules 150. Power module 250 may have an insulative housing. The mating interface of power module 250 may have one or multiple holes with electrical contacts inside. Those electrical contacts, for example, may have flat surfaces that mate with a mating contact inserted into the hole. Power module 250 is configured to receive electrical contacts of power module 350 of the mating connector.

In the example of FIG, 2, the electrical contacts of power module 250 have tails configured for plated through hole attachment, but press fit or other attachment techniques may be used. Power module 250 may be mounted to PCB 210 by pressing the tails into holes in the PCB.

### Guiding Modules of a First Connector

The connector 200 may include guiding modules 220A and 220B of mated guiding modules 120A and 120B, respectively. Each of guiding modules 220A and 220B may include a protruding member configured to fit into an opening of the mating interface of the guiding modules 320A and 320B of connector 300. The protruding member has a base configured for attachment to a PCB, such as with screws. In this example, the protruding member of guiding modules 220A and 220B extends perpendicular to the base and therefore the PCB 210 to which it is mounted. In this example, the distal end of the protruding member is tapered to facilitate engagement with the mating interface of mating guiding modules.

The mated guiding modules 120A and 120B may, when engaged, provide further functions in addition to guidance. For example, the mated guiding modules 120A and 120B may provide latching of connectors 200 and 300 to restrict unintended movement in a direction that would un-mate the connectors (e.g., a direction opposite direction 500). As another example, the mated guiding modules 120A and 120B may be formed of conductive materials, such as die cast metals, which may be connected to ground or power to convey power through the mated connectors However, in other examples, all or part of the guiding modules 220A and 220B may be formed of insulative material.

### Signal Modules of a First Connector

The connector 200 may include signal modules 240A and 240B of mated signal modules 140A and 140B, respectively. Signal modules 240A and 240B are configured to mate with signal modules 340A and 340B of connector 300. During operation, and/or when mated, the signal modules may be configured to pass high-speed signals with high signal integrity. Each of signal modules 240A and 240B may be shaped and sized to receive a mating signal module (e.g., signal module 340A or 340B). In the illustrated embodiment, the signal modules 240A and 240B may include one or more slots with parallel walls between the slots. The signal modules 240A and 240B may each include rows of electrical contacts within the slots adjacent the walls. In this example, a connector with a like mating interface may be mated to signal modules 240A and 240B with like walls of the mating connector inserted into the slots signal modules 240A and 240B and the walls of signal modules 240A and 240B inserted into like slots of the mating connector. In this way, the electrical contacts of the two connectors will engage, making signal paths through the mated connectors.

In the example of FIG, 2, the electrical contacts of signal modules 240A and 240B may have press fit tails. Signal modules 240A and 240B may be mounted to PCB 210 by pressing the tails into holes in the PCB.

### Locking Features of a First Connector

Locking features may be provided in connection with connector 200. The locking features may be integrated into one or more of the modules described elsewhere herein, in separate modules, in the PCB to which the connector modules are mounted, or part of any other component that is rigidly coupled to one or more of the signal modules of connector 200. In the illustrated example, those locking features are within the PCB 210 to which the connector components are mounted. In this example, the locking features associated with connector 200 are provided by holes in PCB 210.

The board 210 to which connector 200 is mounted may include one or multiple holes configured to receive members projecting from or projecting into locking modules of the connector 300. In the illustrated example, the holes receive pegs projecting form the locking modules of the connector 300. A peg may be a protruding member that is elongated in the protruding direction. A peg may be, for example, cylindrical, or substantially cylindrical. Though, in other examples a peg may have a cross section that is square, hexagonal or has some other number of sides. The peg may be used to hold the locking modules to the board. The peg may be threaded or have other features to facilitate attachment to a printed circuit board.

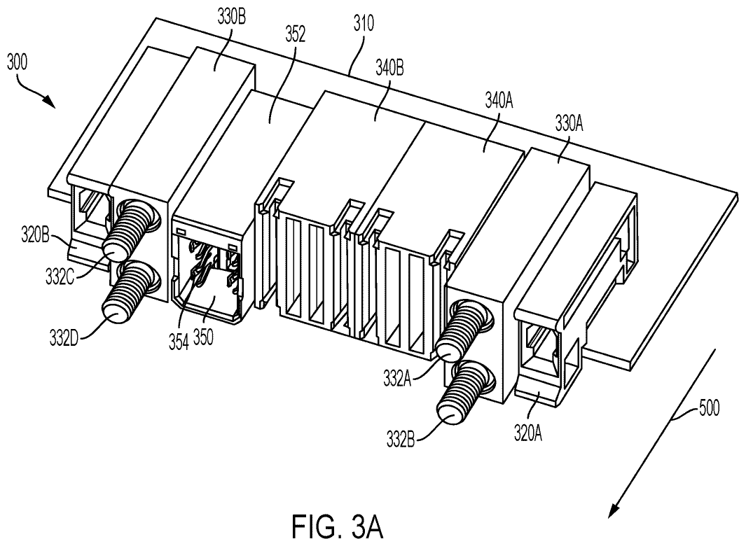

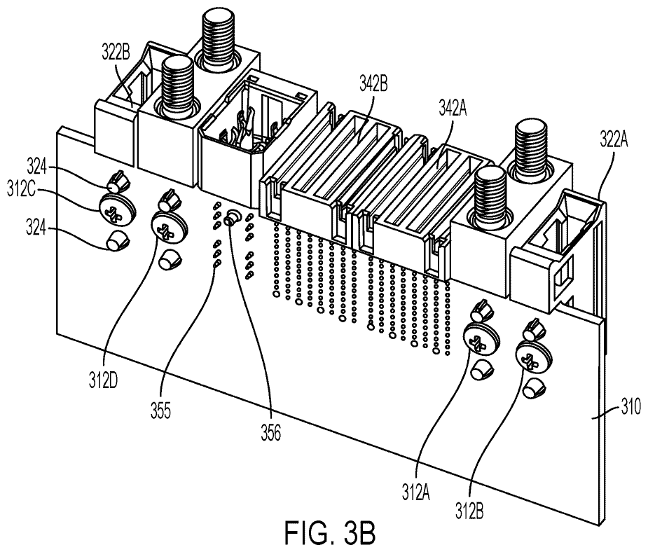

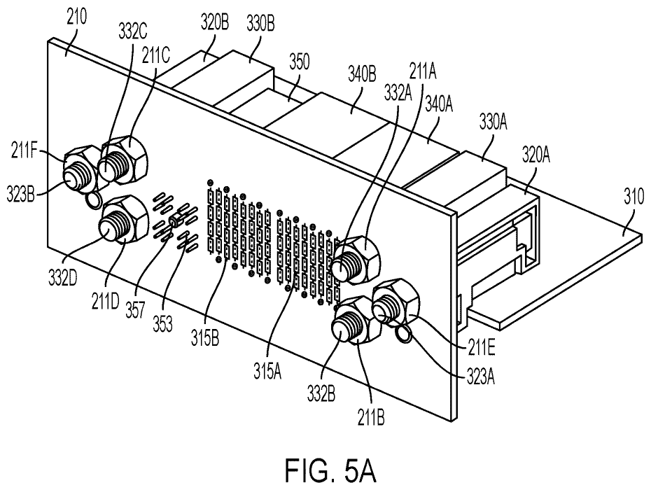

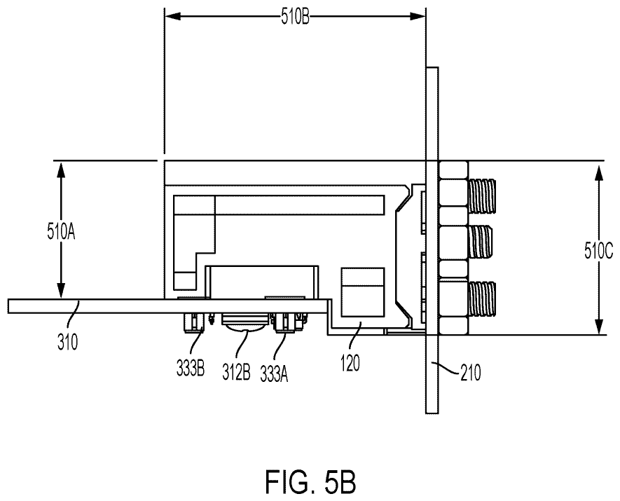

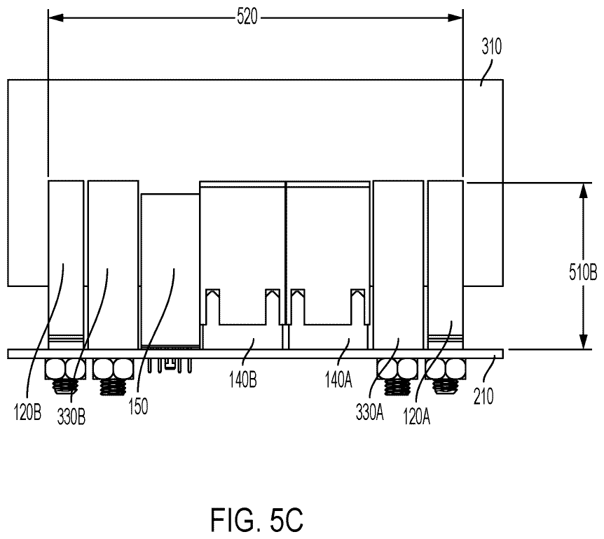

For example, as described herein in relation with FIG. 3A-B and 4, board 210 may include holes such as holes 230A, 230B, 230C and 230D. The locking modules 330A and 330B of connector 300 includes pegs 332A, 332B, 332C and 332D. Each of the pegs is configured to extend into a corresponding hole 230A-D of board 210. In some examples, and as described further herein in relation with FIG. 5A, one or more nuts (e.g., nuts 211A-211D) threaded onto the pegs are used to fasten the board 210 to the locking modules (e.g., by creating contact pressure of the board 210 against the locking modules).

FIG. 3A is a perspective view of a second exemplary board connector 300 mounted to PCB 310 of the interconnection system of FIG. 1, in accordance with some embodiments. FIG. 3B is another perspective view of board connector 300. As described herein, connector 300 may include multiple types of modules mounted on a surface of printed circuit board (PCB) 310. Those modules may be configured such that they collectively mate with connector 200. Exemplary connector 300 includes modules such as a power module 350, one or more guiding modules 320A and 320B, and one or more signal modules 340A and 340B.

### Power Module of a Second Connector

The second module of the mated power modules 150, power module 350, includes one or more electrical contacts 354 provided in an insulative housing 352. The electrical contacts 354 have a mating contact portion that mates with the mating contact portions of the electrical contacts in power module 250. In this example, the electrical contacts 354 include compliant fingers that, when mated, press against flat portions of the electrical contacts in power module 250.

The insulative housing 352 includes a mating interface having an opening in the mating direction 500, and the mating contact portions of electrical contacts 354 extend into the opening. The opening of the mating interface is shaped and sized to receive a power module 250. When a power module 250 is inserted in the opening of power module 350 during mating, the mating contact portions of the electrical contacts 354 enter into the openings in power module 250 for mating. According to some embodiments, the power module may include 4 electrical contacts. In some examples, the mating contact portions of the electrical contacts may be bifurcated. The bifurcated electrical contacts may have a first and second prong. Prior to mating, the electrical contacts may be in a rest state. During mating, the prongs may be offset towards each other.

The electrical contacts 354 may, like the contacts of power module 250, have tails configured for mounting to a PCB or other substrate. In the illustrated example, the tails are conductive posts configured plated through hole attachment.

Tails 355 of the electric contacts 354 may extend into holes in a mounting surface of the PCB 310. For example, the mounting surface of the PCB may include holes plated with conductive material. The plating of the holes may be electrically connected to power or ground planes or other conductive structures within the printed circuit board 310. According to some embodiments, power may be provided to the power module via a power source connected to the power planes within board 310.

Power module 350 may include an attachment post 356. The attachment post 356 may be configured to extend into a hole of the PCB 310, for example, to prevent or mitigate movement of power module 350 relative to board 310.

### Guiding Modules of a Second Connector

The connector 300 may include one or more guiding modules 320A and 320B. As described herein, the guiding modules 320A and 320B may engage with guiding modules 220A and 220B to guide connectors 200 and 300 into position for mating. In the example of FIG. 3A-B, the connector 300 includes guide module 320A of mated guiding modules 120A and guide module 320B of mated guiding modules 120B. Guiding module 320A may be configured to mate with guiding module 220A and the guiding module 320B may be configured to mate with guiding module 220B.

In the illustrated example, guiding modules 320A and 320B have mating interfaces 322A and 322B comprising an opening in the mating direction 500. The opening may be shaped and sized to receive a protruding member of guiding modules 220A, 220B of connector 200. According to some embodiments, part or all of the guiding modules 320A and 320B may be formed of insulative material. For example, guiding modules 320A and 320B may include insulative shells. Alternatively or additionally, the shell may be made of metal, such as diecast metal, or other materials.

As noted in connection with guiding modules 220A and 220B, the mated guiding modules 120A and 120B may, when engaged, provide further functions in addition to guidance. In some examples, the guiding modules further include retention features, such as latches, configured to hold guiding modules 220A and 220B, on the one hand, to guiding modules 320A and 320B. The latching may prevent unintended un-mating of connectors 200 and 300.

Each of the components 320A and 320B may include attachment posts 324 configured to extend into one or more holes of the PCB 310. For example, components 320A and 320B may each have two attachment posts 324. Posts 324 may be shaped and may function as described for posts 333A and 333B. In embodiments in which mated guiding modules 120A and/or 120B provide for ground or power connections, posts 324 may be metal or other conductive material.

Other features may be included instead of or in addition to posts to retain or fasten the modules to a PCB. In the example illustrated, each of the guiding modules 320A and 320B may also include a hole, which is between the two attachment posts in the illustrated example. Screws may extend through the board 310 into each of the holes in order to secure the guiding modules to the PCB. For example, screw 312C may secure guiding module 320B to the board 310 and screw 312B may secure guiding module 320A to the board 310. According to some embodiments, the holes may be threaded, or a threaded insert may be provided therein.

### Signal Modules of a Second Connector

Connector 300 may include one or modules for carrying signals. In this example, connector 300 includes signal modules 340A and 340B, which form a portion of the mated signal modules 140A and 140B. Each signal module may include one or more electrical contacts in an insulative housing. The insulative housing includes a mating interface in the mating direction 500. The mating interfaces of signal modules 340A and 340B may be complementary to the mating interfaces of signal modules 240A and 240B, respectively so that the signal modules of the mating connectors may mate. In the illustrated embodiment, all of the signal modules have the same mating interface, which is configured for hermaphroditic mating. Accordingly, the mating interfaces of signal modules 340A and 340B may be as described above for signal modules 240A and 240B.

As in the configuration illustrated, the mating interfaces of signal modules 340A and 340B include a plurality of recesses 342A and 342B. The recesses may include a plurality of electrical contacts. The mating interface of each may be shaped and sized to receive a mating connector (e.g., signal modules 240A/240B) therein. For example, the protrusions (e.g., slotted configuration) of the signal modules 240A/B may be configured to fit into corresponding recesses of the signal modules 340A/B, such that the electrical contacts of the first and second components make contact in a mated configuration and are electrically connected. According to some embodiments, each recess of signal modules 340A/B may have electrical contacts disposed along two opposing sides of the recess. Each corresponding protrusion of signal modules 240A/B may have electrical contacts disposed along two opposing sides of the protrusion. In a mated configuration, the electrical contacts of the recesses and protrusions make contact and form an electrical connection.

### Locking Modules of a Second Connector

Locking features may be provided in connection with connector 300. The locking features may engage the locking features associated with connector 200 to restrain relative motion of connectors 200 and 300. Locking features, for example, may be implemented as fasteners that engage with complementary fasteners on boards to which mating connectors are mounted. One or more of the fasteners may be threaded fasteners, such as a threshed post or a threaded hole. A locking module, for example, may have two transverse surfaces that each align with a PCB to which one of the mating connectors is mounted. Each surface may have a fastener that may engage a complementary fastener to hold one of those transverse surfaces of the locking module against a respective PCB, thereby holding the two PCBs in set orientation, which in turn holds the connectors mounted to those PCBs in a stable position.

The locking features associated with connector 300 may be integrated into one or more of the modules described elsewhere herein, in separate modules, in the PCB to which the connector modules are mounted, or part of any other component that is rigidly coupled to one or more of the signal modules of connector 200. In this example, those locking features are portions of separate modules, here shown as locking modules 330A and 330B.

In designs in which relative motion of connectors 200 and 300 is restrained by restraining relative movement of the PCBs to which connectors 200 and 300 are attached, the locking modules may collectively have locking features that engage PCBs 210 and 310. In this example, connector 300 has multiple locking modules of substantially the same construction. Each of the locking modules has features for engaging both PCB 210 and 310.

In the illustrated example, each of locking modules 330A and 330B includes pegs for engaging PCB 210. Locking module 330A, for example, includes pegs 332A and 332B configured to extend into corresponding holes 230A and 230B of board 210, respectively. Locking module 330B includes pegs 332C and 332D configured to extend into the corresponding holes 230C and 230D, respectively. Additional members or features may be present to assist in providing a rigid engagement between a locking module and PCB 210. In the configuration illustrated, the pegs are threaded. In the example illustrated herein in FIG. 5A, one or more nuts, such as nuts 211A or 211B, may be tightened onto the threaded pegs to hold PCB 210 against a surface of the locking module 330A.

One or more of the locking modules may also include features for forming rigid attachments between the locking module and PCB 310. In the configuration illustrated, each locking module includes attachment posts configured to extend into one or more holes of PCB 310. For example, attachment posts 333A and 333B of locking module 330A and attachment posts 333C and 333D of locking module 330B may be configured to extend into corresponding holes of PCB 310. In some examples, the attachment posts may be an interference-fit post. For example, each of the posts may be generally cylindrical with relatively thin projections extending radially outwards. The cylindrical body of the posts may have a diameter smaller than the inner diameter of holes on board 310, but the projections may extend to a diameter larger than the inner diameter of the holes. Upon insertion of posts 333A and 333B into corresponding holes of board 310, the projections may deform and or deform the inner surfaces of the holes, causing high frictional force between the surfaces of the holes and posts. This high frictional force may provide retention of the posts in the holes.

Whether the projections of the posts and/or inner surfaces of the holes deforms may depend on the relative hardness of the material used to posts 333A and 333B relative to the materials of the PCB. For example, locking modules 330A and 330B may be metal and the PCB may be formed predominately of epoxy. In this scenario, the deformation may be wholly or predominately in the PCB. The locking modules, for example, may be machined from metal blocks or may be die cast. Alternatively, if the locking modules 330A and 330B are made of a softer material, such as plastic or nylon, the deformation may be wholly or predominately in the projections.

Additional members or features may be present to assist in providing a rigid engagement between a locking module and PCB 310. In the configuration illustrated, each of the locking modules 330A and 330B includes a hole (e.g., hole 335 of locking module 330A), which in this example is located between the two attachment posts. A screw may extend through the board 310 into each of the holes to secure the locking module to the board. For example, screw 312D may secure locking module 330B to the board 310 and screw 312A may secure locking module 330A to the board 310. According to some embodiments, the holes may be threaded and/or a threaded insert may be provided therein. In some embodiments, the hole of modules 330A and 330B may instead be a peg configured to be received by a hole through the board 310.

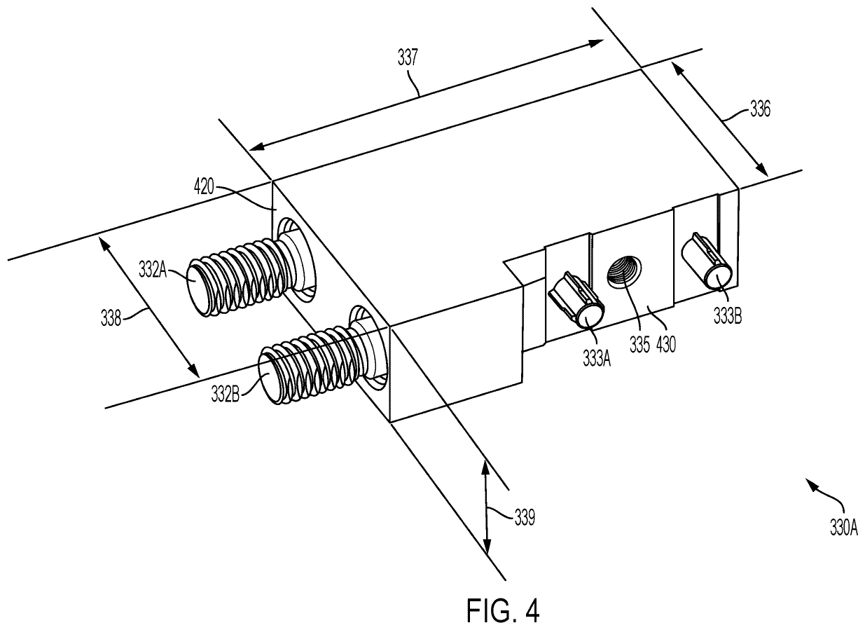

FIG. 4 is a perspective view of a locking module 330A of the board connector 300 of FIG. 3A and FIG. 3B. The locking module 330A may have a first surface 430 configured to be secured to the printed circuit board 310. The locking module 330A may also have a second surface 420 perpendicular to the first surface configured to be secured to the printed circuit board 210. In the example illustrated, locking module 330A has an integral structure such that, when it is secured to PCBs 210 and 310, it rigidly holds PCBs 210 and 310 to restrain relative movement of PCBs 210 and 310, and, therefore, relative movement of second connector 300 and first connector 200.

In the example of FIG. 4, attachment posts 333A and 333B extend perpendicularly from the first surface and are configured to extend into one or more holes of the PCB 310.

In the example of FIG. 4, the locking module 330A has pegs 332A and 332B on the second surface. The pegs 332A and 332B are configured to extend through corresponding holes 230A and 230B of the board 210 of the first connector 200. In some embodiments, the pegs 332A or 332B may instead be holes, such as threaded holes, configured to receive pegs.

According to some embodiments, one or both of the locking modules may have dimensions to fit within a connector constructed with components configured for use in known high-speed and high-density interconnections. As a specific example, the second surface may have a first height identified as dimension 338 and a width identified as dimension 339. Dimension 338 may be between 18 and 25 mm, such as 21.60 millimeters (mm). Dimension 339 may be between 8 and 15 mm, such as 10 mm. In some specific examples, an end opposite the second surface may have a height identified as dimension 336. For example, dimension 336 may be between 15 and 205 mm, such as 17.90 mm. A distance from the second surface and the end opposite the second surface identified as dimension 337 may be between 25 and 45 mm, such as 33.75 mm.

Although the description of FIG. 4 is of locking module 330A, aspects of locking module 330A may be similar or the same as aspects of locking module 330B. For example, locking module 330B may have pegs 332C and/or 332D corresponding to 332A and/or 332B, respectively. The pegs 332C and 332D may be configured to extend through corresponding holes 230C and 230D of the board 210. In some embodiments, the pegs 332C or 332D may instead be holes, such as threaded holes, configured to receive pegs. The locking module 330B may also have attachment posts 333C and 333D corresponding to 333A and 333B, respectively. A hole may be similarly provided on a first surface of the locking module 330B.

FIG. 5A is an alternative perspective view of the interconnection system of FIG. 1. As shown, board connector 200 includes several modules mounted on printed circuit board (PCB) 210. In some embodiments, the modules and/or PCB 210 may include features for attaching and securing the component and PCB.

As described herein, PCB 210 may include one or multiple holes 230A-D configured to receive pegs 332A-D of locking modules 330A and 330B of the connector 300. Each of the pegs is configured to extend into corresponding holes 230A-D of board 210, respectively. In this embodiment, each of nuts 211A-D is used to fasten PCB 210 to the locking modules (e.g., by creating contact pressure of PCB 210 against the locking modules). Similarly, the guiding modules 320A and 320B may have pegs 323A and 323B, respectively. PCB 210 includes corresponding holes through which each peg may extend. Nuts 211E and 211F are used to fasten PCB 210 to the guiding modules 320A and 320B, respectively.

According to some embodiments, the power module 250 may include an attachment post 357. The board 210 may include a corresponding hole through which the attachment post 357 may extend. According to some examples, the attachment post 357 may be configured to form an interference fit, as described above in connection with posts 324. Alternatively or additionally, power module 250 may include a press-fit hold down or other structure to hold power module 250 to PCB 210 until the tails of the contacts of with power module 250 are soldered to PCB 210.

The first component 250 of the power module may also include electrical contacts 353. The electric contacts may be in electrical contact with power planes or other conductive structures within the printed circuit board 210. In this example, the contacts have tails 353 that extend through holes in PCB 210 and may be soldered, such as with plated through hole soldering technology, to make electrical and mechanical connection to PCB 210.

FIG. 5A also reveals a mounting footprint on PCB 210 for each of the signal modules 340A and 340B. Such footprints are shown here as footprints 315A and 315B, respectively. In this example, each footprints 315 and 315B includes multiple parallel rows. Each of the rows includes pairs of holes, with each pair within an antipad, formed by an opening in the power and ground planes within the PCB. The holes within the antipads may be electrically connected to tails of signal conductors within the signal modules. The signal tails, me be pressfit tails that fit within the holes. The holes may have a plating that is electrically connected to signal traces or other conductive structures within the printed circuit board 210. Between the pairs of holes in each row are additional holes, which may be electrically connected to tails of ground conductors within the signal modules. In this example, the ground tails may also be pressfits. However, other attachment mechanisms may alternatively or additionally be used. For example, the holes visible in the lower surface of PCB 210 on FIG. 5A may connect to pads on the opposite surface and the tails may be surface mount soldered to those pads.

In the illustrated example, the adjacent rows have similar configurations, but adjacent rows are offset such that the pairs of holes in adjacent rows are not aligned in a direction perpendicular to the rows. The centerlines of the pairs in one row may be offset, for example, from the centerline of an adjacent pair in each adjacent row by a distance equal to approximately 50 to 80% of the center-to-center distance of the pair. Such a configuration enables high-speed and high-density interconnections.

As shown in FIG. 3B, a similar footprint may be use for mounting signal modules 342A and 342B to PCB 310.

FIG. 5B is a side view of the interconnection system 100, and FIG. 5C is a top plan view of the interconnection system 100. The indicated dimensions illustrate that, by enabling board-to-board connections that are resistant to vibration, a high-density interconnection is achieved. As a specific example, a distance 510B between a first end where the modules are mounted to the board 210 and a second end of the modules opposite the first end may be between 30 and 40 mm, such as 33.75 mm. The height 510C of an end of the modules mounted to the board 210 may be between 18 and 30 mm, such as 22.50 mm. The height 510A of the mating interface of a module of connector 300 when mated to a component of connector 200 may be between 15 and 25 mm, such as 17.90 mm. The width 520 of connector 200 and/or connector 300 may be between 70 and 100 mm, such as 82.90 mm.

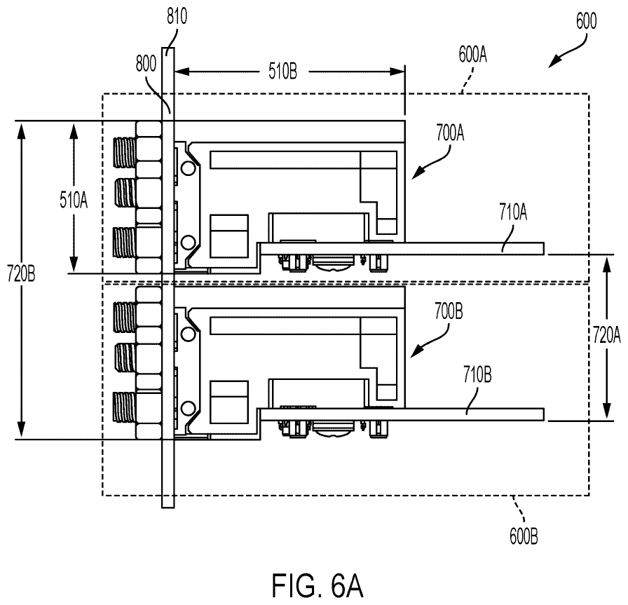

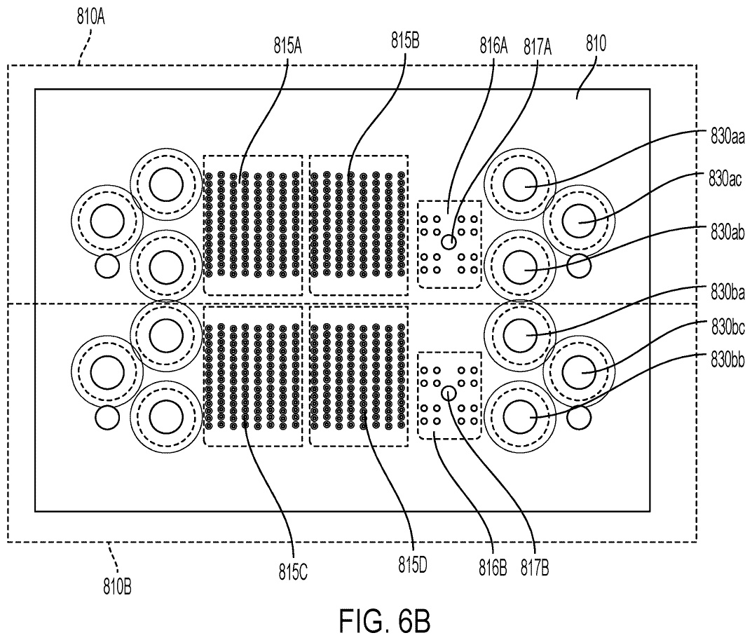

FIG. 1 illustrates an interconnection system 100 connecting a first PCB to a second PCB. In other examples, the techniques and components describe herein may be used in other system configurations. For example, multiple connectors may be mounted to one PCB such that multiple PCBs may be connected to or through that PCB. For example, FIG. 6A is a side view of an illustrative system 600. In this example, a subassembly 800 may have two connectors mounted to PCB 810. Each of the connectors may mate with a respective connector 700A or 700B, each mounted to a respective PCB, 710A or 710B. In the example of FIG. 6A, the system 600 includes a first set of modules 600A and a second set of modules 600B. Each set of modules may have the configuration of mated connectors 200 and 300, described above. The modules mounted to PCB 810, for example, may have the configurations describe above in connection with connector 200, and those mounted to PCBs 710A and 710B may have the configurations described above in connection with connector 300.

When both sets of modules 600A and 600B are in a mated configuration, the printed circuit boards 710A and 710B may be spaced on a pitch 720A. The pitch 720A may be between 18 and 30 mm, such as 24.25 mm. The height of the height 720B of the two sets of modules 600A and 600B may be between 40 and 60 mm, such as 46.75 mm.

FIG. 6B is a detailed view of an exemplary printed circuit board (PCB) 810. The subassembly 800 may include first and second sets of modules as described herein. Each of the first and second sets may be affixed and/or secured to a portion 810A or 810B of the board. The portions 810A and 810B may be configured and may function in substantially the same way.

For example, the portion 810A may include footprints 815A and 815B for signal modules and portion 810B may include footprints 815C and 815D for signal modules. Each of the footprints 815A . . . 815D may be as described above for footprints 315A and 315B.

Each portion 810A and 810B may also include features for attaching power modules. Each portion may include a corresponding hole 817A and 817B for through which attachment posts of the power modules may extend. The attachment post may be as described above in connection with connector 200, for example.

Each portion 810A and 810B may also include features for engaging locking modules. Each of the locking modules engaged to PCB 810 may have a configuration that is the same as or similar to the configuration of locking module 330A described herein and may include pegs configured to extend into corresponding holes 830aa, 830ab, 830ba, and 830bb of board 810, respectively. According to some embodiments, the pegs may be threaded. In some examples, and as illustrated herein in FIG. 5A, one or more nuts, such as nuts 211A or 211B, may be used to create contact pressure of the board 810 against a surface of the locking modules.

Each portion 810A and 810B may also include features for engaging guiding modules. Each the guiding modules may have pegs. The board 810 includes corresponding holes 830ac and 830bc through which each peg may extend. Nuts, which may be similar to nuts 211E and 211F, may be used to fasten the guiding modules to board 810.

Each portion 810A and 810B may also include features for making electrical and/or mechanical connections to power modules. PCB 810, for example, may include holes 816A. The holes 816A may be through holes through which electrical connectivity may be provided between tails 353 and power planes or other conductive structures within the printed circuit board 810.

In the illustrated embodiments, two interconnected PCBs are aligned at right angles to one another, with the edge of one PCB facing a surface of the other. In other configurations, the interconnected PCBs may be parallel to one another or may be aligned in an orthogonal configuration, in which the interconnected PCBs are orthogonal to one another with an edge of one PCB facing an edge of the other.

Likewise, in the illustrated embodiments, signal and power modules are mounted to PCBs using press fit tails. Tails of other configurations may be used to connect some or all of the signal and power contacts to a PCB. The tails may be, for example, configured for surface mount soldering or pin in paste mounting.

In the illustrated embodiments, connectors were formed of modules, each designed for a specific function. Connectors may be constructed in which components of the connector perform multiple functions. For example, connector components may have contacts for both signal and power connections, or both power and guidance, for example.

Such alterations, modifications, and improvements are intended to be part of this disclosure and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

All definitions, as defined and used herein, should be understood to control over dictionary definitions, definitions in documents incorporated by reference, and/or ordinary meanings of the defined terms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A locking module configured for use with board-mounted connector modules, the locking module comprising:
a first surface and a second surface;
a plurality of attachment posts extending from the first surface;
a threaded hole in the first surface; and
one or more pegs extending from the second surface.

2. The locking module of claim 1, wherein the locking module comprises an integral body comprising the first surface, the second surface, the plurality of attachment posts, the threaded hole and the one or more pegs.

3. The locking module of claim 2, wherein the second surface is perpendicular to the first surface.

4. The locking module of claim 1, wherein the locking module is metal.

5. The locking module of claim 1, wherein the plurality of attachment posts comprise projections.

6. The locking module of claim 5, wherein the plurality of attachment posts are configured to making an interference-fit attachment when pressed into holes of a PCB.

7. An electrical connector comprising the locking module of claim 1 in combination with a plurality of signal modules, wherein the plurality of signal modules and the locking module are disposed in a linear array.

8-9. (canceled)

10. An automotive electronic system comprising the electrical connector of claim 7 in combination with a first printed circuit board and a second printed circuit board, wherein:
the second printed circuit board has holes therethrough;
the electrical connector is mounted to the first printed circuit board with the first surface of the locking module mounted against a surface of the first printed circuit board;
the electrical connector is a first connector;
the first connector is mated to a second connector mounted to the second printed circuit board; and
the one or more pegs extend through the holes of the second printed circuit board.

11-18. (canceled)

19. A subassembly of an automotive electronic system, the subassembly comprising:
a printed circuit board (PCB) comprising a first surface and a plurality of holes therethrough; and
an electrical connector comprising a plurality of modules disposed in a linear array on the first surface of the PCB, wherein:
the plurality of modules comprise one or more of a power module, a signal module or a guiding module;
the plurality of holes through the PCB are configured to receive a threaded peg; and
the plurality of holes through the PCB are disposed in the linear array between adjacent ones of the plurality of modules.

20. The subassembly of claim 19, wherein:
the electrical connector comprises the signal module; and the signal module comprises:
one or more recesses; and
signal contacts disposed within the recesses and configured to mate with signal contacts of a complementary connector when the complementary connector is mated to the electrical connector.

21. The subassembly of claim 19, wherein:
the connector comprises the power module; and
the power module comprises a receptacle, the receptacle comprising one or more recesses configured to receive power contacts of a complementary connector.

22. An electrical connector configured to mate with a complementary connector and configured for mounting to a surface of a first printed circuit board (PCB), the electrical connector comprising a plurality of modules in a linear array, the plurality of modules comprising:
a signal module having a mounting side facing in a first direction and configured for mounting against the surface of the first PCB and a mating side facing in a second direction configured for mating with the complementary connector; and
a locking module comprising a first side facing in the first direction and a second side facing in the second direction, wherein the first side comprises a first fastener configured for engaging a first complementary fastener to secure the locking module against the surface of the first PCB and the second side comprises a second fastener configured for engaging a second complementary fastener to secure the module against a surface of a second PCB.

23. The electrical connector of claim 22, wherein the first fastener or the second fastener comprises a threaded hole.

24. The electrical connector of claim 23, wherein the locking module further comprises a post extending from the side of first side or the second side comprising the threaded hole.

25. The electrical connector of claim 22, wherein the first fastener or the second fastener comprises a threaded post.

26. The electrical connector of claim 22, wherein the first side is perpendicular to the second side.

27. The subassembly of claim 19, wherein:
the electrical connector comprises one or more of the guiding modules, each of the one or more guiding modules comprises one or more pegs, and the one or more pegs are configured to pass through one or more corresponding holes through the PCB.

28. The subassembly of claim 19, wherein:
the electrical connector comprises one or more of the guiding modules, each of the one or more guiding modules comprises:
a first surface configured for mounting against the first surface of the PCB; and a threaded hole in the first surface of each of the one or more the guiding modules, and
the electrical connector further comprises a screw configured to pass through a hole in the PCB and engage the threaded hole so as to secure the one or more guiding modules to the PCB.

29. The subassembly of claim 19, wherein the power module comprises a plurality of power contacts, and each of the plurality of power contacts is bifurcated.

30. The subassembly of claim 19, wherein;
the electrical connector comprises the signal module comprising a plurality of signal contacts;
the signal module comprises a plurality of recesses, each of the plurality of recesses comprising two opposing sides; and
signal terminals of the plurality of signal contacts are disposed along the two opposing sides of each recess of the plurality of recesses so as to provide a mating interface configured to mate with signal contacts on two sides of a corresponding protrusion of a complementary connector when the complementary connector is mated to the connector.
